(19) United States
(12) Patent Application Publication
(10) Pub. No.: US 2014/0270334 A1
(43) Pub. Date: Sep. 18, 2014

(54) COVERT MARKING SYSTEM BASED ON MULTIPLE LATENT CHARACTERISTICS

(71) Applicant: LASERLOCK TECHNOLOGIES INC., Washington, DC (US)

(72) Inventors: Neil ALPERT, Washington, DC (US); Paul DONFRIED, Richmond, MA (US); Norman A. GARDNER, Bala Cynwyd, PA (US)

(73) Assignee: LASERLOCK TECHNOLOGIES INC., Washington, DC (US)

(21) Appl. No.: 14/049,776

(22) Filed: Oct. 9, 2013

Related U.S. Application Data
(60) Provisional application No. 61/780,001, filed on Mar. 13, 2013.

(51) Int. Cl. G06T 1/00

(52) U.S. Cl. CPC G06T 1/0021
USPC 382/100

(57) ABSTRACT

Described are systems for combining multiple latent characteristics within a pigment such that with certain specialized knowledge and tools the specific pigment can be uniquely authenticated. The system takes advantage of the rapid proliferation of artificial light sources that are characterized by combinations of narrow band light sources that combine to simulate natural, or broadband light sources. With knowledge of the ambient lighting spectral emissions and the ability to illuminate the subject with an alternative light source with different spectral emissions, it is possible to determine the presence of the latent characteristics within the pigment. In some embodiments of the system, a smartphone including a CMOS or CCD sensor and a LED light source, could be combined with software to authenticate all of the latent characteristics. These characteristics can be combined with each other in different proportions to mass customize unique solutions for each customer or product line.

### REFERENCE TO RELATED APPLICATION

This application claims the priority of U.S. Provisional Patent Application No. 61/780,001, filed on Mar. 13, 2013, the contents of which are herein incorporated by reference.

### FIELD OF THE DISCLOSURE

This relates to the field of authentication and counterfeit detection, and more specifically to systems employing pigments, inks, etc., to apply overt and covert marks to material goods, which can subsequently be authenticated through the use of restricted knowledge and/or special inspection tools.

### BACKGROUND

The issues of authentication and counterfeit deterrence can be important in many contexts. Although it is apparent that authenticating money is important, authentication and avoidance of counterfeiting can also be important in many less obvious contexts. For example, improved verification and counterfeiting prevention mechanisms would be very useful in, for example, verifying the contents of shipping containers, verifying the source of goods, etc. Counterfeit products are, by definition, unauthorized copies of a product, its packaging, labeling, and/or its logo(s). Attractive targets for counterfeiters are items with significant brand equity or symbolic value, where the cost of production is below the market value.

In the commercial manufacturing world, it is not uncommon for counterfeit or otherwise unauthorized goods to be manufactured, distributed, and sold in direct competition with authentic goods. Counterfeit articles can so closely resemble genuine goods that consumers readily confuse the counterfeit articles with the authentic articles. In other circumstances, the manufacturer segments the world market for different sales and distribution practices, so that the “counterfeit” goods may be essentially identical to authorized goods. Further, in many instances, a manufacturer produces goods under license from an intellectual property owner, and thus sales outside the terms of the license agreement are also “counterfeit.”

A wide variety of attempts have been made to limit the likelihood of counterfeiting. For example, some have tried to assure the authenticity of items by placing encoded or unencoded markings thereon (e.g., an artist's signature on his or her painting). Unfortunately, as soon as the code is broken and/or the markings can be replicated, this method becomes worthless for authentication purposes.

### SUMMARY

Described are devices and methods for authentication and counterfeit detection using multiple pigments. Two or more pigments may be blended together in a single mark.

There currently exist multiple latent characteristics that can be used to authenticate pigmented subjects by unique overt and covert means. In most cases, the inspection tool is the human eye, which may be aided by a specialized light source. Common examples would be subjects pigmented with ultraviolet marks which are not visible under natural or artificial light, unless the artificial light source emits very strongly in the narrowband ultraviolet portion of the spectrum and nowhere else. The authentication of a US Drivers License by TSA when the place the US Drivers License under a Black Light provides such an example.

These conventional applications of latent characteristics have a few challenges. For example, under certain illumination conditions, the marks are visible to the human eye and therefore can easily be detected by counterfeiters. In the TSA example, everyone who is being authenticated sees the marks revealed when the US Drivers License is placed under the black light. In order for these authentication mechanisms to work, specialized illumination sources and/or inspection devices are required. While this may not be an issue for specialized authentication applications, it generally does limit the broad application of the methods at the consumer or mass market level.

Further, when these methods have been applied for the mass market, like UV marks on US Drivers Licenses and Credit Cards, the methods themselves have quickly been counterfeited, rendering the authentication capability worthless. Due to the requirements of high speed, production line printing it has not been possible to combine multiple different latent characteristics within the same pigment. When it has been possible to combine multiple different latent characteristics within a single pigment, each characteristic has required unique specialized equipment for authentication/inspection.

It has been found that these challenges may be overcome by combining multiple different latent characteristics within a single pigment that allow for multiple, unique, overt and covert authentication mechanisms to be exercised. It has been found that the resulting pigments can be formulated into inks and dyes that fully comply with the requirements of high speed production line printing and marking equipment. Therefore, they may not require any new, specialized equipment for application and use.

The resulting pigments can also combine latent characteristics and formulation techniques that allow for mass customization of the solution, allowing for customer and/or product specific unique authentication. The system and methods may take advantage of the widespread proliferation of artificial light sources with unique narrowband, spectral emission characteristics—such as a compact fluorescent lamp (CFL), a light emitting diode (LED), etc.—and the ability to distinguish these illumination sources from natural (or broadband) light sources.

There may be provided a system for combining multiple overt and covert characteristics within a pigment that takes advantage of the variety of natural and artificial light sources commonly available. The broadband and narrowband characteristics of these light sources may be used to authenticate marks produced using these pigments. These marks may be authenticated by viewing or inspecting these marks under at least two different lighting conditions or in at least two different ways.

An example of such system may include producing a mark using a pigment that includes two or more identifiable characteristics. For example, the mark may include a pigment that includes specific phosphorescence elements that are excited at distinctly different wavelengths. One phosphoresce element could be excited by a narrowband wavelength within the human visible spectrum, while another could be excited by an infrared wavelength outside of the human visible spectrum.

These characteristic elements of the pigment may be used to create cryptographic marks on the subject product. The marks may then only revealed or authenticated under certain lighting conditions and/or with specialized filters applied to receiving sensor(s).

Embodiments and examples are not limited to two characteristics. In fact, the number of characteristics can be proportional to the overall security and resilience desired. For example, some embodiments may employ three, four, five, six or more security characteristics. While many characteristics may be established by the pigment in the subject, it will not be known by potential counterfeiters which of these characteristics are utilized and under what lighting conditions they are authenticated.

The combination of specific characteristics and exact formulation of the pigment can itself create a unique pigment. This allows for the mass customization of pigments for the marking of goods such that unique pigments can be produced for individual brand owners and products. This provides the ability to uniquely authenticate marks for the product or brand owner, based partially or entirely on the characteristics of the pigment.

In some embodiments, the pigments are used to create cryptographically encoded, machine readable marks which introduce an additional layer of authentication, security and resiliency. In such embodiments, the marks can be applied using existing standards such as UPC Bar Codes, QR Codes, etc. or the marks can be applied using proprietary or secret machine readable formats.

In some embodiments, there may be provided a method of authenticating a material good including illuminating a security mark associated with a material good using a first lighting condition, wherein the security mark comprises one or more pigments and has a first latent security characteristic when illuminated under the first lighting condition; determining whether the first latent security characteristic is authentic; illuminating the security mark associated with a material good using a second lighting condition, wherein the security mark has a second latent security characteristic when illuminated under the second lighting condition; and determining whether the second latent security characteristic is authentic. The material good can be authenticated if both the first latent security characteristic and the second latent security characteristic are authenticated.

The first and second latent security characteristics may derive from one or more phosphor particles blended together in the security mark. Only the particles of a similar size may be selected to create the single mixture pigment, which is used as the security mark. Accordingly, the security mark may have a particle size distribution that shows a high concentration in relative a narrow range, for example, ±20% from a mean value, preferably ±10% from a mean value, and still preferably ±5% from a mean value.

The first lighting condition may be produced by a first light source and the second lighting condition is produced by a second light source. The first latent security characteristic and/or the second latent security characteristic may not be visible to an un-aided human eye in ambient lighting conditions.

The first latent security characteristic may have a different color, hue and/or pattern when the security mark is illuminated by the first lighting condition. The security mark may produce a different emissive response for first light condition than the second lighting condition. The first or second light source may not be visible to the human eye. The first or second light source may be a light source from a mobile device—for example, a camera phone. The first latent security characteristic and/or the second latent security may be authenticated using a digital image sensor.

In some embodiments, there may be provided a security mark associated with a material good may include one or more pigments that have a first latent security characteristic when illuminated under a first lighting condition and has a second latent security characteristic when illuminated under a second lighting condition. The material good can be authenticated by verifying both the first latent security characteristic and the second latent security characteristic.

### BRIEF DESCRIPTION OF THE DRAWINGS

FIG. 1 illustrates the complete energy spectrum highlighting the extremely small portion of which is visible to the un-aided human eye;

FIG. 2 illustrates the spectral emission of natural light from the Sun at noon. It can clearly be seen that in the visible portion of the spectrum natural light emits broadly and with roughly the same intensity

FIG. 3 illustrates a number of types of artificial fluorescent light, including compact fluorescent, and shows the spectral emission from two different varieties, both of which are characterized by multiple narrowband emissions, quite unique and dis-similar from broadband natural light sources

FIG. 4 illustrates a number of types of Light Emitting Diode (LED) artificial light sources and the spectral emission of a typical White LED which shows a narrowband peak in the blue spectrum and another peak in the yellow spectrum

FIG. 5 illustrates the spectral emissions of various light sources

FIG. 6 illustrates the spectral emissions of various light sources

FIG. 7 illustrates an example of a particle size distribution of a mixture pigment.

### DETAILED DESCRIPTION

Described are marks, marking systems, marking methods, detection systems and detection methods that use multiple independent characteristics of a single mark or pigment to securely identify tangible products. The specific formulations and characteristics of these pigments may be restricted.

The marks or the pigments according to this disclosure may be applied to any goods or substrates which would benefit from having security information encoded thereon, and examples of such goods or substrates include, non-exclusively, collectibles, money, documents, tickets, credit cards, products, etc. Non-limiting examples of materials from which suitable substrates may be made include paper, wood, synthetic polymers and metals.

The marks or the pigments according to this disclosure may be configured to emit multiple detectable signals in response to illumination at multiple different wavelengths. These wavelengths may correspond to emission wavelengths of one or more selected light sources that are to be used as inspection tools or authentication/verification methods.

i. Light Sources

Different light sources may include natural and artificial light sources that are commonly available, broadband and narrowband light sources. Examples of these light sources include, non-exclusively, natural sunlight, fluorescent light, LED light, electromagnetic radiation (EMR), etc. EMR is characterized by its narrow bandwidth, which may be as narrow as 10 nm in width, and more preferably, 5 nm or less.

In some embodiments, an illumination source that has narrow spectral band peaks, exemplified by certain types of fluorescent lamps and LED lamps, may be used as an illumination source for a detection system. In such an illumination source, a combination of narrow wavelength bands (typically three primary color wavelengths) when added may simulate illumination from a broadband source such as sunlight, having a given color temperature. Accordingly, an illumination source as described may be applied to a wavelength absorptive pigment that is matched to at least one narrow band in the source, by virtue of a band at which the pigment is strongly absorptive. The preferably narrow absorptive band of the pigment is at least partly complementary to one of the color peaks emitted from the lamp.

An exemplary narrow band illumination source for use may have discrete spectral peaks at particular wavelengths at visible blue, green and red wavelength bands. When these spectral peaks are added at appropriate relative amplitudes, the illumination is perceived by the eye as substantially white broadband light. For example, a blue peak at 440 nm±15 nm, a green peak at 544 nm±15 nm and a red peak at 611 nm±15 nm are provided. Preferably, the bands are added at energy levels that cause the sum of the three sources to appear as a nominal color, for example the white of sunlight. However, the technique can also produce a shift in appearance for light that is otherwise balanced, provided that there is a contribution from a plurality of narrow spectral bands.

In daylight illumination conditions, namely under light from the sun, the full visible spectrum is substantially represented. In sunlight, a nominal range of colors is visible because the light energy is spread over the entire range of visible wavelengths. Under such conditions, the appearance of an illuminated subject is determined substantially only by the pigmentation of the subject, which determines the reflective spectrum of the subject. Thus, in sunlight, a red pigmented object appears red, a blue pigmented object appears blue, etc. Having evolved in sunlight, humans are adapted to distinguishing among illuminated objects based on their coloration, as illuminated by a white or broadband source.

There are some instances in which colored illumination is employed for effect. In day to day lighting applications, colored illumination might be undesirable because the colored lighting causes a subject to appear abnormal or unnatural. In other applications, colored light might be used deliberately because it is considered to make certain subjects more appealing than they might appear under flat spectrum broadband (“white light”) illumination. Typically, colored or tinted illumination involves adjusting the relative power level of a source toward generally redder “warm” tones or toward generally cooler and possibly harsher or more revealing bluer tones.

A light source might be tinted sufficiently that objects that should look “white” assume the tint of the light source to some extent. The ability of the human eye to subjectively detect subtle tints is limited and fades over time. After a time of exposure to a tinted light source, the light source seems white. The tint level and hue of lighting can have various effects. Fresh meats may look more appealing in slightly red light. Fresh vegetables may be more appealing in green or yellow light. Persons may have a skin tone that looks healthier with a bit of extra red.

In order to be effective for the foregoing purposes, differences in the color balance of light sources is preferably subtle. The desired effects (healthy appearance or the like) might be defeated if a situation occurred wherein an article was successively illuminated by one light source and then another with a different tint. Illumination might be used to alter the appearance of a subject in a more radical way. A particular tint could be used to reveal a certain color and to wash out or mask certain other colors.

The emission spectrum of light sources has been extensively studied. This is particularly the case for fluorescent lamps because there is an opportunity to adjust the tint of the light source by selecting among particular phosphor compositions and proportions of different compositions used to coat the inside of the fluorescent lamp (typically an elongated tube). Different phosphors have different emission spectra, but for physical or chemical reasons, the spectra generally have characteristic wavelengths where the light emission is relatively stronger and other wavelengths that are weaker.

Illumination is classified as to color temperature, which is a measure of the extent to which the spectrum tends to blue or to red. Solar radiation has a nominal color temperature of 5800° K., which can be considered the color of daylight, although daylight varies over the course of a day from a “whiter” color distribution (perhaps bluer is more accurate) to a redder one. According to JIS Standard Z 9112 (1990), there are standard ranges of color temperature for fluorescent and other lamps. Two scales used are:

TABLE 1
Standard Ranges of Color Temperatures

| JIS Classification | T_{cp} (K) | IEC Publ. 81 equivalent |
|---|---|---|
| Daylight | 5700-7100 | Daylight |
| Day White | 4600-5400 | (no equivalent) |
| White | 3900-4500 | Cool White |
| Warm White | 3200-3700 | White |
| Incandescent Color | 2600-3150 | Warm White |

The color temperature represents a measure of the wavelength of the peak energy in a distribution of light energy versus wavelength. However the spectral light energy distribution of a light source typically is not a continuous spectrum. The energy distribution of fluorescent lamp has peaks and gaps due to the emission characteristics of the individual phosphors that line the fluorescent lamp tube.

Ordinary fluorescent lamps have calcium halophosphate phosphors lining the lamp tube. These phosphors have relatively broad and continuous spectra. Their emission extends over a range of wavelengths with a relatively constant level of power versus wavelength. The emission of such phosphors at wavelengths longer than 600 nm is limited, tending to make the illumination relatively blue or white, compared to daylight, which is somewhat more yellow or reddish by comparison. Combinations with additional phosphors have been proposed to supply additional red illumination. The emissions of several phosphors are summed in an effort to better synthesize the color of daylight. Lamps constructed using these concepts are wide-band spectrum lamps, although narrower band phosphors may be included in the mix to adjust the contour of the spectrum.

An alternative type of fluorescent lamp may use narrow emission band phosphors with spectral peaks at respective primary colors, and much lower power levels at other wavelengths. According the “Phosphor Handbook,” CRC Press, pp. 367-373, the perception of the human eye is such that most colors can be effectively reproduced by combining light energy from narrow blue, green and red spectral bands. Particular suggested color bands are centered at wavelengths 450, 540 and 610 nm. This is the concept used in video display devices that control the brightness of red, blue and green dots at each pixel position of a display screen.

By selecting and optimizing particular phosphor compositions and combinations used in a light source, the peak emissions wavelengths can be selected as to their center wavelengths. The proportionate light energy applied at the three peaks can be varied by choice of phosphors and their proportions. In this way, the spectral balance of light intended to simulate white light or daylight is adjusted. However, the spectrum of the light is not broadband and actually is comprised of a set of wavelength peaks of relative amplitudes and wavelengths selected by the phosphors used and the recipe of concentrations of phosphors used in lining the lamp.

ii. Pigment Blending

After multiple (two or more) peak emission wavelengths of the light source(s) are selected to be used for authentication, a pigment that has responsive emission characteristics at these selected wavelengths need to be formulated. Such a pigment may be made from a combination of multiple marking agents, where each marking agent has an emission characteristic responding at one of the selected wavelengths.

The marking agents may include phosphor elements and other similar pigments. The marking agents may be referred to as “latent marking agents.” The latent marking agent denotes a material that emits a detectable signal only after being activated. The latent marking agent encompasses invisible inks and pigments. In some embodiments, the latent marking agent is activated by electromagnetic radiation (EMR), preferably narrow bandwidth EMR (defined herein as EMR not more than 10 nm in width), more preferably EMR having a bandwidth of 5 nm or less, even more preferably single wavelength EMR. In some embodiments, the activation or excitation wavelength may be at least 900 nm. For example, the blended pigment may have two activation or excitation wavelengths, one falling between 915 nm and 990 nm and the other falling between 1550 nm and 1800 nm.

Non-limiting examples of materials suitable for the combination of marking pigments include rare earth metals, such as, non-exclusively, europium, dysprosium, samarium or terbium, combined with a chelating agent, such as, e.g., an organic ligand, to form a biketonate, acetonate or salicylate. Additional examples include yttria phosphors, inorganic phosphors, Ciba Geigy Cartax CXDP and UV visible Eccowhite series from Eastern Color and Chemical. The pigments preferably comprise an inorganic material, and in certain embodiments, the marking agent is free of organic dyes. The selection of the pigments is largely dictated by the desired excitation wavelengths and emission wavelengths. In certain embodiments, it is preferred that the excitation wavelengths be longer than the emission wavelengths.

In some embodiments, the marking agent is luminescent pigment Z, K, S, ZH and/or GE (available from Stardust Material, New York, N.Y.), which is dispersed in an aqueous or organic varnish at a 2% to 5% ratio and applied to a substrate via printing or coating. This mark visibly fluoresces when exposed to a specific infrared light range. The illuminated color can vary depending upon the type of pigment utilized.

In some embodiments, an apt pigment is a rare earth oxide that has been further optimized by additional processing as a sulphide or fluoride. An illustrative example is holmium oxysulphide (Ho2O2S), optimized to have a strong narrow absorption peak at 545 nm. The pigment has a tan or sand color in sunlight and dramatically shifts to a violet red appearance under the narrow band illumination source. This color shift occurs because the pigment absorbs most of the 545 nm green and the reflected color is only composed of the remaining red and blue narrow bands.

The method and/or apparatus for “affixing” the mark or the pigment onto the subject is not limited. The term “affix” as used herein is intended to denote a durable (but not necessarily permanent or unresolvable) association between the mark or the pigment and the subject on which the mark or the pigment is to be applied. Preferably, the association between the mark/pigment and the subject may be sufficiently durable to remain functionally intact through the period of intended use of the subject, and the affixation of the mark or the pigment on the subject may be direct (e.g., adsorption and/or absorption) or indirect (e.g., adhesive). Suitable marking apparatus include, e.g., printers, including inkjet, flexographic, gravure and offset printers, pens, stamps, and coaters.

The combination of pigments is preferably provided in a marking composition. Marking compositions generally comprise combination of pigments and a solvent. Preferred solvents include methyl ethyl ketone, ethanol and isopropanol. A solvent soluble resin, such as a Lawter resin, can be used to avoid precipitation of the marking agent from solution. The combination of pigments can further comprise additives, stabilizers, and other conventional ingredients of inks, toners and the like. In embodiments, various varnishes or additives, such as polyvinyl alcohol, Airvol 203 and/or MM14 (Air Products and Chemicals, Inc., Allentown, Pa.), propylene carbonate, Joncry wax varnishes, and Arcar overprint varnishes, can be added to the combination of pigments to reduce absorption into the substrate and ensure that the combination of pigments remains on the surface of the substrate.

In some embodiments, multiple phosphor elements that each emits fluorescence at different wavelengths may be blended together in a single mixture pigment such that the resulting mixture pigment can have different emission characteristics responding at different wavelengths. For example, the mixture pigment can emit different fluorescence at different wavelengths, or emitting different signals at different wavelengths.

The mixture pigment may be characterized as having multiple absorptive peaks (i.e., reflective spectral gaps) that match the multiple emission peaks of the selected light source(s). The absorptive peaks of the pigment can be matched to multiple emissions peaks that have been previously selected for use as authentication mechanism.

In some embodiments, a particular pigment having a nominal color when illuminated with a true broadband source is specifically matched to a narrow band illumination source as described. Preferably, the pigment has an absorptive peak that is sufficiently strong and sufficiently matched to the wavelength band of one of the illumination source peaks that the overall color or hue, from the summed proportions of reflected colors from the pigment, shifts substantially and noticeably based on whether the particular narrow band keying peak wavelength is present in the illumination source. Preferably, a plurality of such pigments are used to produce a pigment combination for a security mark. By blending these pigments together to produce a pigment combination, another variable is added to the resulting securing mark.

Preferably, the pigments are used in combinations. The different pigments of the combinations may be matched to different narrow band peaks of a single illumination source or may be matched to narrow band peaks in multiple illumination sources. For example, a security mark formed from a pigment combination of two or more pigments may have two or more responses when exposed to a single illumination source. The visual distinctiveness of the mark can be a result of the combination of these responses to the single illumination source.

The combination of pigments may include two or more pigments that respond to different light sources. For example, a first pigment of the pigment combination may be matched to the spectral emissions of a first light source and a second pigment of the pigment combination may be matched to the spectral emissions of a second light source. Additional pigments that are matched to the spectral emissions of additional light sources—for example 2, 3, 4, 5, 6, 7, 8, 9, 10 or more pigments matched to additional spectral emissions—may be included in the pigment combination. Each of these pigments in the combination may be matched to a different light source and/or different emissions peaks in a single light source.

a. Absorption Peak Bandwidth Matching the Excitation Peak Bandwidth

In some embodiments, multiple different pigments (particles) having different absorption peaks may be mixed/blended into a single pigment or a single mark such that the resultant mixture pigment has multiple absorption peak bandwidths that match the corresponding emission peak bandwidths of the light sources. For example, if the mixture pigment has two absorptive peaks at a first wavelength and at a second wavelength, a width of the first wavelength is matched to the width of corresponding emission peak of the light source, and a width of the second wavelength is also matched to the width of corresponding emission peak of the same or different light source.

The mixture pigment that has absorptive bandwidths that closely match the excitation bandwidths of the light source(s) may allow for a more accurate and precise authentication, with less errors. By matching the width of absorptive peaks of the pigment to the width of emission peaks of the light source, the pigment may show a clear signal change between when illuminated at non-responsive wavelengths and when illuminated at responsive wavelengths. Further, the signal change between the different responsive wavelengths may also become more apparent.

The absorptive bandwidths of the blended pigment may be considered as substantially matching the respective excitation bandwidth of the light source(s), if the absorptive bandwidths fall within ±20% of the respective excitation bandwidths, more preferably ±10%, still more preferably ±5%, and still more preferably, the absorptive bandwidths precisely matching the respective excitation bandwidths.

Alternatively or additionally, the absorptive bandwidths of the blended pigment may be considered as substantially matching the respective excitation bandwidth of the light source(s), if the absorptive wavelengths fall within ±20 nm of the respective excitation wavelengths, more preferably ±10 nm, still more preferably ±5 nm, and still more preferably, the absorptive wavelengths precisely matching the respective excitation wavelengths.

For example, the monitoring may be achieved by a detector that is exclusively tuned to the emission wavelengths to which the blended pigment is made to be responsive. The expression “exclusively tuned” indicates that the detector detects only a narrow band of wavelengths within ±5 nm of the emission wavelength.

b. Matching the Particle Size

In some embodiments, multiple different pigments (particles) are mixed/blended together into a single pigment or a single mark such that only the particles of a similar size from the different pigments are mixed/blended. For example, only the particles having a diameter of a certain range may be selected to create the mixture pigment.

Having a relatively focused particle size distribution (e.g., most particles are of the same or similar size) may allow the blended pigment to have a well-defined width of emission wavelengths. In other words, the mixture pigment can have clear emission characteristics.

For example, there may be two types of pigment particles, each responding at two different desired emission wavelengths. Although the first instinct would be to mix these particles together to formulate a mixture pigment that has responsive emissions at the desired emission wavelengths, in some preferred embodiments, the particles are not mixed together unless they have a similar particle size.

Matching the particle size of different phosphor elements may ensure that the resulting mixture pigment or mark have well-defined emission characteristics—e.g., narrow emission bandwidths, narrow excitation bandwidth, clear contrast between peaks and non-peaks, etc., especially because the particle size contributes to inherent emission characteristics of the composition.

In some embodiments, only the pigment particles that have a particle size within a certain range are blended together to create a mixture pigment with multiple characteristics. The mixture pigment that results from such particles will accordingly have a particle size distribution that shows a high concentration in relatively a narrow range.

FIG. 7 shows an example of a particle size distribution of a mixture pigment, referred to as PTM545/N-X.

The particle size distribution shown in FIG. 7 is a list of values that define the relative amount of different size particles by volume percentage dispersed in the pigment composition. The measurement technique used to analyze the pigment PTM545/N-X is the Coulter Counter, which is a type of electroresistance counting methods.

Other measurement techniques may be used instead to analyze the particles in a blended pigment and to achieve a similar particle size distribution, and examples of the techniques include, non-exclusively, dynamic light scattering methods, photoanalysis, optical counting methods, electroresistance counting methods, sedimentation techniques, laser diffraction methods, acoustic spectroscopy or ultrasound attenuation spectroscopy.

Referring to FIG. 7, the analyzed mixture pigment includes particles, a 5% of which have a particle size that is 4.8 μm or less, a 25% of which have a particle size that is 7.8 μm or less, a 50% of which have a particle size that is 10.5 μm or less, a 75% of which have a particle size that is 13.6 μm or less, and a 95% of which have a particle size that is 18.3 μm or less. Accordingly, a vast majority of the particles in the blended pigment, PTM 545/N-X, have a particle size between a narrow range of about 7 μm to 18 μm.

The particle size distribution shown in FIG. 7 is given only as an example, and other distributions with different quantum dots may be considered sufficiently narrow (e.g., showing sufficiently similar sized particles) in accordance with this disclosure. For example, a narrow particle size distribution in accordance with this disclosure may include a distribution showing that more than 60% of particles in the blended pigment have a particle size within ±20% of a mean (or a median) value, more preferably, 70% of particles in the blended pigment have a particle size within ±20% of a mean (or a median) value, and still more preferably, 80% of particles in the blended pigment have a particle size within ±20% of a mean (or a median) value.

The meaning of the narrow particle size distribution is not limited to the above standards. Instead, it may include a distribution showing that more than 50% of particles in the blended pigment have a particle size within ±10% of a mean (or a median) value, more preferably, 60% of particles in the blended pigment have a particle size within ±10% of a mean (or a median) value, and still more preferably, 70% of particles in the blended pigment have a particle size within ±10% of a mean (or a median) value.

c. Overt and Covert Characteristics

The multiple characteristics of the mixture pigment (e.g., multiple emission bandwidths) may be selected such that a few of the characteristics are detectable by unaided eyes, thereby making them an overt characteristic of the mixture pigment, while the rest of the characteristics are not detectable without the use of a special light source, thereby making them a covert characteristic. The overt characteristics may be used to hide the covert characteristics in the mixture pigment.

In some embodiments, the mixture pigment may include two phosphor elements, where one phosphor element could be excited by a narrowband wavelength within the human visible spectrum (e.g., an overt first characteristic), while the other could be excited by an infrared wavelength outside of the human visible spectrum (e.g., a covert second characteristic embedded within a single pigment or mark with the overt first characteristic). For example, the blended pigment may have two excitation wavelengths, one at 915 nm to about 990 nm, and the other at 1550 nm to about 1800 nm.

In some embodiments, a first latent marking agent may be adapted to emit a first signal at a first emission wavelength after being irradiated with infrared radiation at a first excitation wavelength, and a second latent marking agent may be adapted to emit a second signal at a second emission wavelength after being irradiated with infrared radiation. The infrared radiation that excites the second latent marking agent to fluoresce can be the same as or different from the infrared radiation that excites the first latent marking agent.

The multiple emission wavelengths (or absorptive bandwidths) of the blended pigment may differ by at least 5 nm, more preferably by at least 50 nm. This feature may ensure that the multiple characteristics of the blended pigment do not overlap, thereby preventing confusion, and may even allow for multi-level or redundant levels of protection and authentication, where an authorized user having low-level clearance can detect only a few of the multiple characteristics of the blended pigment while an authorized user of high level clearance can detect a higher number or all of the embedded characteristics in the blended pigment.

In some embodiments, the blended pigment may include first and second phosphor elements. When the first phosphor emits a first signal in response to being irradiated with radiation at a first excitation wavelength, the second phosphor is latent, or is hidden. In other words, a person inspecting the marked items based on the first phosphor characteristic will have no way of knowing the existence of the second character due to the second phosphor, because the second phosphor activity is subdued and latent while the first phosphor is emitting. Likewise, when the second phosphor is emitting, the first phosphor may be latent or hidden.

Further, either or both the first and second latent marking agents may be invisible to an unaided eye in ambient lighting, and may be activated only after being excited by certain irradiation.

One example of a blend pigment is described herein. The blend pigment comprises flexographic pigment and gravure pigment.

Disperse Stardust Materials Product Z (CAS 68585-88-6) at a ratio of 2% to 5% in a solution of Polyvinyl Alcohol, water and 0.5% to 2% Surfynol 104PG surfactant with standard mixing equipment. Pass mixture through a wet micronizer to reduce the pigment size to between 3 microns to 8 microns. Then wetting agents, dispersing agents and color dyes or pigments (omit if colorless is desired) are added to the mixture. Adjust viscosity by either increasing water content or adding a viscous PVA MM14 additive. Once mixture has ideal viscosity and suspension of solids, then this mixture or ink is ready to print by standard flexographic/gravure press. Print ink on a white or clear substrate such as paper or film via flexographic/gravure printing press. To the naked eye, the printed ink will have no noticeable difference than any other ink. When the printed ink is excited at 930 nm, which is delivered by a hand-held laser apparatus, a noticeable color will fluoresce, and when the apparatus is removed, the ink will appear as before. If no colored dye or pigment is added to the ink, the color will be a bright glowing green, with red dye/pigment the color will be a bright glowing light, and with black dye/pigment the color will be green. When the laser apparatus is used in total darkness, the fluorescence will appear brighter. When the same ink is excited at 1550 nm, a different color will fluoresce (in colorless it will appear yellow).

As describe above, the blended marks or pigments according to this disclosure may be configured to have emission characteristics responding at emission peaks of various different types of light sources or irradiation. In fact, one advantage of the marks and method of formulating the marks according to this disclosure is that it can take advantage of wide-spread, low-cost light sources and/or irradiation sources such as a mobile phone, a camera phone. The available light sources and appropriate configurations of the marks and light sources for use in accordance with this disclosure are explained in further detail below.

iii. Light Sources as Authentication Tools

FIG. 1 shows the overall energy emission spectrum and highlights the extremely small portion of this spectrum which is visible to the un-aided human eye, specifically the portion of the spectrum from 380 nm to 780 nm. Previous approaches to pigmentation of subjects for authentication targeted the consumer or mass market focused on this portion of the emission spectrum so that the human eye could be used as the inspection tool.

With the rapid proliferation of devices that incorporate Charge Coupled Device (CCD) and Complimentary Metal Oxide Semiconductors (CMOS) sensors, such as camera phone and other electronic devices including cameras, it became apparent to the inventors that these devices could be used as inspection tools in ways that would not necessarily need to reveal to the human eye, either the latent characteristics or the specific authentication mechanism being employed. Instead, a variety of widely available, low cost devices can be utilized as inspection tools.

FIG. 2 shows the spectral emission of natural light, emanating from the Sun, at midday. It is characterized by what is referred to as broadband light, meaning the emissions are strong and essentially consistent across the entire visible spectrum, from 380 nm through 780 nm. Historically, artificial light sources have attempted to mirror this broadband emission characteristic, principally through the burning of a filament, such as in the incandescent light bulb. This tended to provide very similar broadband emission characteristics. However, as a result of these broadband illumination techniques, much of the energy emitted by incandescent light sources falls outside of the visible spectrum. For example, this is why incandescent or halogen light bulbs are hot to the touch. They emit a tremendous amount of energy in the invisible, infrared portion of the spectrum. As a result, these light sources are not considered energy efficient, because much of the input energy is released outside of the visible range and is therefore not perceived by human beings as illumination.

Modern artificial light sources are principally designed to be highly energy efficient. FIG. 3 illustrates examples of fluorescent lights and their emission spectrum. An exemplary compact fluorescent “bulb” is shown in FIG. 3. This form of bulb is available from a number of manufacturers, and typically has an emission spectrum that is designed to resemble the emission of an incandescent bulb, e.g., with a tungsten filament, operated in turn at a power level intended to simulate the spectrum of the sun.

Therefore, these compact fluorescent bulbs are daylight balanced by selection of phosphors and operational parameters. They typically have electronic ballast operable to apply a preferably high frequency alternating current, so as to be substantially flicker-free and to closely match the color of daylight. However such lamps dissipate only about 25% of the electrical power of an incandescent tungsten filament bulb operable at the same light output level.

As can be seen in the spectrum emission charts shown in FIG. 3. these artificial light sources have radically different emission characteristics than traditional broadband light sources such as natural sunlight and incandescent sources. Modern artificial light sources, which are quickly becoming prevalent and replacing incandescent sources, have narrowband emissions which are combined to simulate the appearance the white light or natural light.

These different spectral emissions that characterize modern artificial light sources and distinguish them from natural light sources can be used according to some embodiments of the invention.

FIG. 4 illustrates a Light Emitting Diode (LED), some common artificial light sources that utilize LEDs, and a graph of the spectrum emission characteristics of a White LED. The emission characteristics of LEDs are quite different from those of natural light as well. In the case of this white LED, the spectrum emission, which is illustrated, shows a clear narrowband peak in the blue portion of the spectrum, around 450 nm and in the yellow portion of the spectrum, around 550 nm.

In a LED, atoms that have been excited to a higher energy state, return to a steadier state, and in the process release a photon, or light energy. To create a White LED, a common technique is to layer a yellow phosphor coating on top of a semiconductor which emits a photon in the Blue portion of the visible spectrum. These lead directly to the spectral emission output illustrated in FIG. 4. The narrowband peak at 450 nm is generated by the blue photons emitted directly by the semiconductor material. The other peak at 550 nm is created by the yellow phosphor, which is excited by the energy from the 450 nm blue light, and emits light energy in the yellow and red portions of the spectrum with a peak at 550 nm. The combination of the blue and yellow narrowband peaks is perceived by the human eye as white light—even though the underlying energy characteristics are dramatically different then natural light.

In some embodiments, a smartphone with integrated CMOS sensor and LED light source is used as an inspection tool for the multiple latent characteristic pigment without revealing any restricted knowledge to the user/operator of the device. For example, a software application operating on a smartphone could cause the device to take a first image of the pigmented subject using the existing ambient light. Since the overt characteristics of the pigmented subject are known, the emission characteristics of the ambient light source can be interrogated. The software application can then cause the smartphone to turn on the LED light source at maximum strength and capture a second image. The characteristics of the LED light source can be known in advance based on the manufacturer's specifications. This allows for the comparison of the two images and the application of specific narrowband filters that are chosen to reveal the desired characteristics, the specific wavelengths and combinations of which are part of the restricted knowledge and not know to the user. In such an embodiment, the multiple latent characteristics of the pigment can be authenticated without revealing any restricted knowledge to the user/operator.

There are many other envisioned embodiments of the invention, including those that utilize other capabilities which may be present in such devices. These could include, but are not limited to multiple sensors (CCD, CMOS, etc.) implemented as front facing cameras, rear facing cameras, ambient light sensors, infrared sensors used as proximity sensors, etc.

It is also envisioned that embodiments of the invention could extend to a wide variety of devices which are now incorporating such sensors and light sources including, automobiles, ATMs, surveillance equipment, etc.

Further, the security marks or pigments according to this disclosure may be used in conjunction with other technologies described in, for example, the following publications. U.S. Pat. No. 7,939,239 relates to the selective use of light sources and subjects having markedly strong (or markedly weak) light emission and absorption characteristics in certain corresponding spectral bands. By matching and mismatching illumination and absorption in certain bands, a spectrally matched (or mismatched) subject is caused to assume a distinctly different appearance based upon the illumination source used. Particular illumination sources and pigments were disclosed wherein a strong difference in appearance is achieved.

U.S. Pat. No. 6,483,576 relates to the use of multiple marking agents (pigments) that fluoresce at different wavelengths. The subject may have first and second pigments embedded thereon, where the first pigment is responsive to a first wavelength and the second pigment is responsive to a second wavelength. Such multiple characteristics that stem from multiple pigments used in marking the subject may operate as multi-level security clearance system for uniquely identifying and cross-validating the subject. The described systems and methods enable the direct marking of goods during the manufacturing process and enable detection/cross-validation of the marks so that the goods are uniquely identified and tracked throughout the stream of commerce. In addition, the markings are not readily reproducible and detectable with commonly available devices and so that the markings contain sufficient information for product authentication, identification, and tracking. The system can be readily altered periodically to hinder counterfeiting.

U.S. Provisional Application No. 61/766,372 relates to systems, devices, and methods for authenticating material goods that take advantage of the wide-spread mobile computing devices with a digital camera and an artificial light source.

The above patents and application may be incorporated in any one or more embodiments disclosed herein, and their disclosures are hereby incorporated by reference in their entireties.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A method of authenticating a material good comprising:
illuminating a security mark associated with a material good using a first lighting condition, wherein the security mark comprises one or more pigments and has a first latent security characteristic when illuminated under the first lighting condition;
determining whether the first latent security characteristic is authentic;
illuminating the security mark associated with a material good using a second lighting condition, wherein the security mark has a second latent security characteristic when illuminated under the second lighting condition; and
determining whether the second latent security characteristic is authentic;
wherein the material good is authenticated if both the first latent security characteristic and the second latent security characteristic are authenticated.

2. The security mark of claim 1, wherein the first and second latent security characteristics are created by two or more types of phosphor particles in the security mark.

3. The security mark of claim 1, wherein the security mark comprises two or more types of pigment particles blended together, and the blended particles have a particle size distribution that shows 50% or more of the particles have a size that is within 20% of a mean value.

4. The method of claim 1, wherein the first latent security characteristic or the second latent security characteristic is not visible to an un-aided human eye in ambient lighting conditions.

5. The method of claim 1, wherein the first latent security characteristic and the second latent security characteristic are not visible to an un-aided human eye in ambient lighting conditions.

6. The method of claim 1, wherein the first latent security characteristic comprises a different color, hue or pattern when the security mark is illuminated by the first lighting condition.

7. The method of claim 1, wherein the security mark produces a different emissive response when illuminated by the first lighting condition than when illuminated by the second lighting condition.

8. The method of claim 1, wherein the first latent security characteristic or the second latent security is authenticated using a digital image sensor.

9. The method of claim 1, wherein the first or second lighting condition is not visible to an un-aided human eye.

10. The method of claim 1, wherein the first lighting condition is produced by a first light source and the second lighting condition is produced by a second light source.

11. The method of claim 10, wherein the first or second light source is a light source from a mobile device.

12. The method of claim 10, wherein the first or second light source is a light source from a camera phone.

13. A security mark associated with a material good comprising:
one or more pigments that has a first latent security characteristic when illuminated under a first lighting condition and has a second latent security characteristic when illuminated under a second lighting condition;
wherein the material good can be authenticated by verifying both the first latent security characteristic and the second latent security characteristic.

14. The security mark of claim 13, wherein the security mark comprises two or more types of phosphor particles.

15. The security mark of claim 13, wherein the security mark comprises two or more types of pigment particles blended together, and the blended particles have a particle size distribution that shows 50% or more of the particles have a size that is within 20% of a mean value.

16. The security mark of claim 13, wherein the first latent security characteristic or the second latent security characteristic is not visible to an un-aided human eye in ambient lighting conditions.

17. The security mark of claim 13, wherein the first latent security characteristic and the second latent security characteristic are not visible to an un-aided human eye in ambient lighting conditions.

18. The security mark of claim 13, wherein the first latent security characteristic comprises a different color, hue or pattern when the security mark is illuminated by the first lighting condition.

19. The security mark of claim 13, wherein the security mark produces a different emissive response when illuminated by the first light condition than when illuminated by the second lighting condition.

20. The security mark of claim 13, wherein the first or second lighting condition is not visible to an un-aided human eye.

21. The security mark of claim 13, wherein the first latent security characteristic or the second latent security is configured to be authenticated using a digital image sensor.

22. The security mark of claim 13, wherein the first lighting condition is produced by a first light source and the second lighting condition is produced by a second light source.

23. The security mark of claim 22, wherein the first or second light source is a light source from a mobile device.

24. The security mark of claim 22, wherein the first or second light source is a light source from a camera phone.
